(19) United States
(12) Patent Application Publication
(10) Pub. No.: US 2011/0154994 A1
(43) Pub. Date: Jun. 30, 2011

(54) WINE AERATOR TOWER

(75) Inventor: Rio Sabadicci, Rancho Santa Fe, CA (US)

(73) Assignee: Area 55, Inc., Carlsbad, CA (US)

(21) Appl. No.: 12/885,272

(22) Filed: Sep. 17, 2010

Related U.S. Application Data
(60) Provisional application No. 61/243,483, filed on Sep. 17, 2009.

(51) Int. Cl. C12H 1/00

(52) U.S. Cl. 99/323.1

(57) ABSTRACT

A wine aerator system includes a wine aerator having a body defining a fluid flow path extending from a top opening of the body to a bottom opening of the body. The fluid flow path of the wine aerator is configured to introduce air into a flow of wine passing from the top opening to the bottom opening of the body. The aerator system also includes a tower configured to receive the wine aerator, the tower including a base configured to be disposed on a horizontal surface and to receive a wine glass. A stem extends upwardly from the base when the base is disposed on the horizontal surface. The stein includes an adapter configured to removably receive the wine aerator such that the wine aerator is positioned above the base such that the wine glass can be positioned on the base and under the wine aerator to receive wine exiting the bottom opening of the wine aerator.

This application claims the benefit of Provisional Patent Application Ser. No. 61/243,483, filed Sep. 17, 2009, entitled “WINE AERATOR TOWER,” which is incorporated herein by reference for all purposes.

### BACKGROUND

The present invention is directed to an improved liquid dispensing system, and more particularly, an improved wine dispensing system that is operative to facilitate the dispensing of a wine through a wine aerator into a wine glass.

Wine aerators are used to mix wine with air in order to improve the taste of the wine. A wine aerator is typically held in one hand above a wine glass while the wine is poured from a bottle into a receiving aperture of the wine aerator. The wine passes through the wine aerator and into the glass after being mixed with air. After the desired amount of wine has been dispensed into the glass, the wine aerator is put down. Since there is residual wine in the wine aerator, the wine aerator is usually put onto a plate or a towel such that the residual wine does not spill onto a table or other stainable surface. When the wine aerator is subsequently picked up to dispense another glass of wine, some of the residual wine in the wine aerator can drip onto the table, someone's clothes or other stainable item, which is undesirable.

### SUMMARY

An example of a wine aerator system includes: a wine aerator that includes a body defining a fluid flow path extending from a top opening of the body to a bottom opening of the body, where the fluid flow path is configured to introduce air into a flow of wine passing from the top opening to the bottom opening of the body. The system further includes a tower configured to receive the wine aerator. The tower includes: a base configured to be disposed on a horizontal surface and to receive a wine glass; and a stem configured to extend upwardly from the base when the base is disposed on the horizontal surface. The stem includes an adapter configured to removably receive the wine aerator such that the wine aerator is positioned above the base such that the wine glass can be positioned on the base and under the wine aerator to receive wine exiting the bottom opening of the wine aerator.

Embodiments of such a wine aerator system may include one or more of the following features. The base provides a first aperture and the system further includes a splash guard configured to be removably placed into the first aperture and configured to reduce or inhibit splashing of drops of liquid being vertically received by the splash guard relative to a smooth surface. The splash guard includes a screen positioned substantially parallel to and level with or below the receptacle platform with the splash guard received by the first aperture positioned substantially parallel to and level with or below the receptacle platform with the splash guard received by the first aperture. A floor of the first aperture provides a convex portion. The convex portion of the floor of the first aperture has a conical shape. The splash guard includes a plurality of cross members each having at least one top surface extending partially horizontally and partially downward. A cross section of at least one of the cross members is triangular. The base provides at least one fingernail aperture adjacent to and in fluid communication with the first aperture to facilitate removal of the splash guard from the first aperture. The stem is configured to be removably coupled to the base. The splash guard further includes a back panel coupled to the outer frame and the back panel includes a conical upper surface with a center of the conical upper surface being closer to the screen than a periphery of the conical upper surface.

An example of a wine aerator tower for removably receiving a wine aerator includes: a base including a receptacle platform providing a first aperture; and a splash guard configured to be removably placed within the first aperture. The splash guard includes: an outer frame sized to fit within the first aperture; and a screen attached to and held by the outer frame, the screen providing at least a portion of a top of the splash guard. The wine aerator tower further includes a stem coupled to the base, and the stem includes a support adapter configured to removably receive a wine aerator such that the wine aerator is positioned vertically over the splash guard at a height sufficient to allow a receptacle to be positioned on the base below the wine aerator.

Embodiments of such a wine aerator tower may include one or more of the following features. A floor of the first aperture is conical with a center of the conical floor being higher than a periphery of the floor of the first aperture. The splash guard comprises a plurality of cross members each having at least one top surface extending partially horizontally and partially downward. A cross section of at least one of the cross members is triangular with a peak centered on a top of the at least one cross member. The base includes a transition member that extends upwards from the receptacle platform, a second aperture is provided by the transition member and the stem is coupled to the base via the transition member. The screen of the splash guard is positioned substantially parallel to and level with or below the receptacle platform with the splash guard received by the first aperture. The splash guard includes a back panel coupled to the outer frame. The back panel of the splash guard comprises a conical upper surface with a center of the conical upper surface being closer to the screen than a periphery of the conical upper surface. The base provides at least one fingernail aperture extending away from and in fluid communication with the first aperture.

### BRIEF DESCRIPTION OF THE DRAWINGS

FIG. 1 is a perspective view of a wine aerator tower holding a wine aerator.

FIG. 2 is a perspective view of the wine aerator tower of FIG. 1 without the wine aerator.

FIG. 3 is a left side elevation view of the wine aerator tower of FIG. 2.

FIG. 4 is a right side elevation view of the wine aerator tower of FIG. 2.

FIG. 5 is a front elevation view of the wine aerator tower of FIG. 2.

FIG. 6 is a rear elevation view of the wine aerator tower of FIG. 2.

FIG. 7 is a top plan view of the wine aerator tower of FIG. 2.

FIG. 8 is bottom plan view of the wine aerator tower of FIG. 2.

FIG. 9 is a perspective view of a base of the wine aerator tower of FIG. 2.

FIGS. 10A, 10B and 10C are top elevation, cross-section, and bottom elevation views, respectively, of a splash guard of the wine aerator tower of FIG. 2

### DETAILED DESCRIPTION

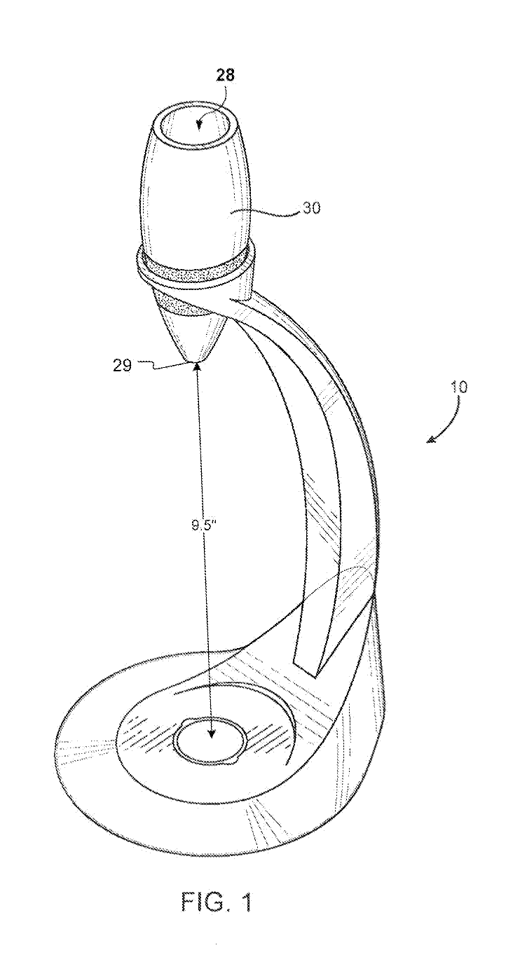

With reference to FIG. 1, a wine aerator tower 10 holds a wine aerator 30. The wine aerator 30 is a device that aerates wine or other liquid with air. U.S. Pat. No. 7,614,614, entitled “Improved Venturi Apparatus,” describes such aerators and is incorporated here by reference in its entirety. Other types of aerators could also be used with the wine aerator tower 10.

The wine aerator tower 10 is configured to hold the wine aerator 30 securely while a wine glass or other receptacle is placed on the wine aerator tower 10 below the wine aerator 30.

The wine aerator 30 includes a top opening 28 and a bottom opening 29 that are joined by a fluid flow path. A person pours wine through the top opening 28, the wine flows through the wine aerator 30, is mixed with air at some point along the fluid flow path, the wine exits the bottom opening 29 and tills the receptacle. The wine aerator 30 remains in the wine aerator tower 10 after the person has filled and removed the receptacle. Details of the wine aerator tower 10 will now be described.

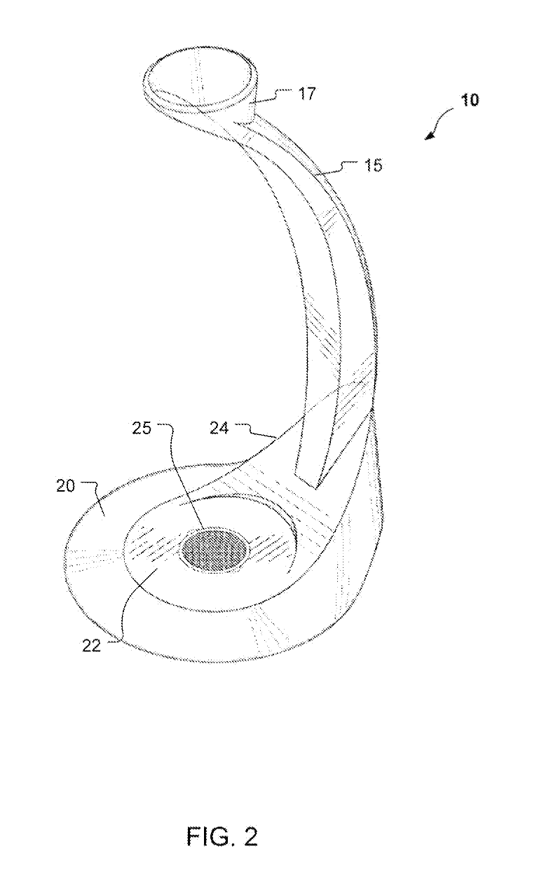

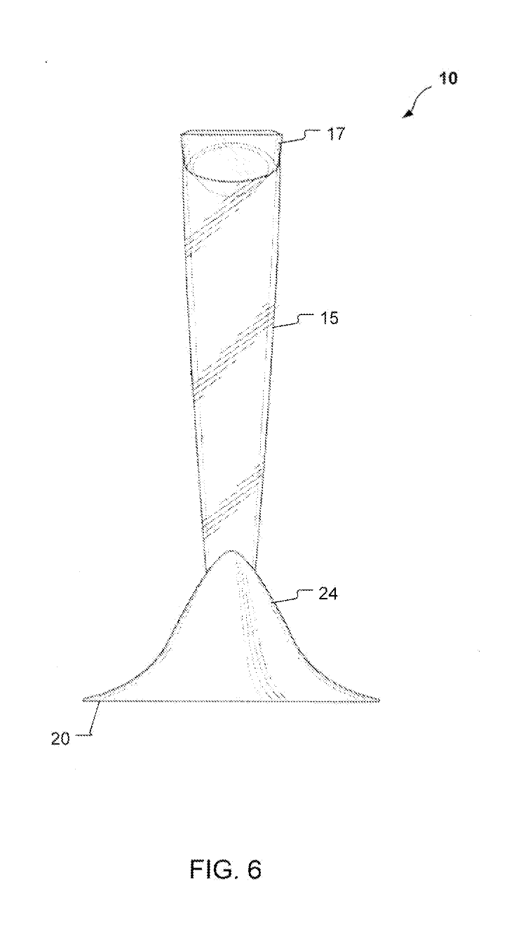

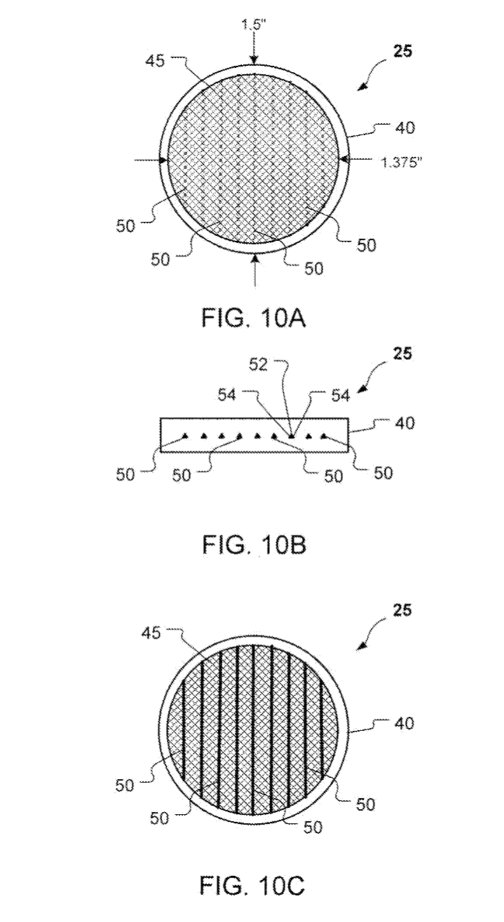

With reference to FIGS. 2-8, the wine aerator tower 10 includes a stem 15, a base 20, and a splash guard 25. In this embodiment, the stem 15, the base 20 and the splash guard 25 are three separate pieces. Alternatively, two or more of the stem 15, the base 20 and the splash guard 25 could be integrated. The stem 15 and the base 20 can be made of molded plastic, wood, metal or other rigid material. The base 20 and the splash guard 25 are configured to reduce or inhibit splashing of drops of liquid (e.g., wine) dropping vertically from the aerator 30 onto the splash guard 25 as opposed to or relative to these drops falling on a smooth surface, e.g., that may be slightly curved or flat. The splash guard 25 is further described below in reference to FIGS. 10A-10C.

The stem 15 includes a support adapter 17 that is configured to removably receive the wine aerator 30. The support adapter 17 is sized and disposed such that the wine aerator 30 fits securely within the support adapter 17 and does not move significantly when liquid is being poured into the wine aerator 30. The support adapter 17 of this embodiment is circular in cross section. Alternatively a semicircular (e.g. greater than half a circle) support adapter could also be used. Other support adapters could be, for example, square, rectangular, elliptical or triangular in cross section.

The base 20 includes a receptacle platform 22 and a transition member 24. The receptacle platform 22 is configured to receive the splash guard 25 such that a receptacle can be stably seated against the receptacle platform 22. The transition member 24 and the stem 15 are sized and disposed such that the support adapter 17 is centered over the splash guard 25 and the receptacle platform 22 at a height sufficient to allow a wine glass or other receptacle to be placed on the receptacle platform 22 below the wine aerator 30 when the wine aerator 30 is in the support adapter 17. The stem 15 can be integral to the transition member 24, glued to the transition member 24 or, as here, inserted within an aperture formed in the transition member 24.

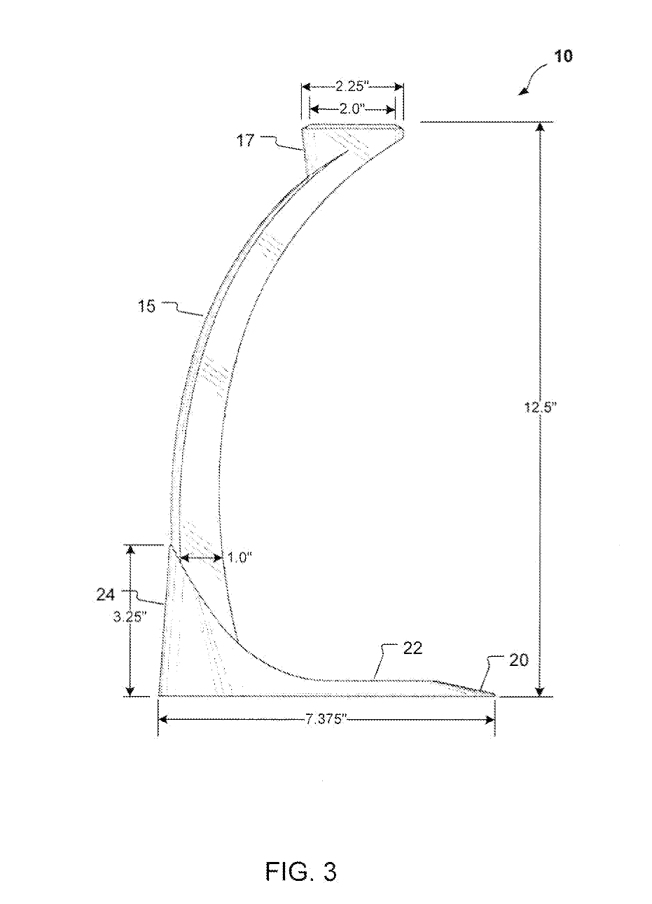

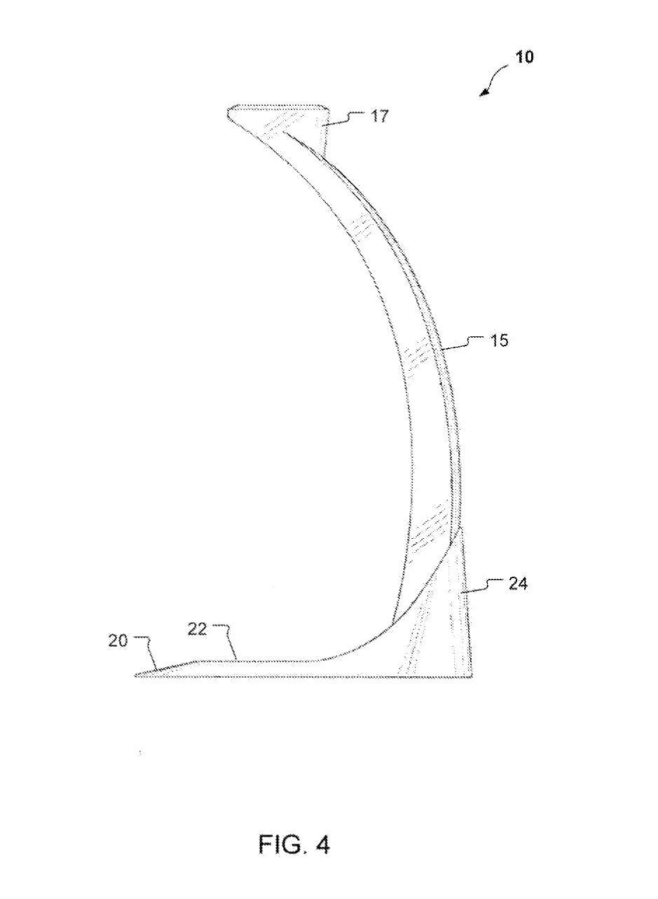

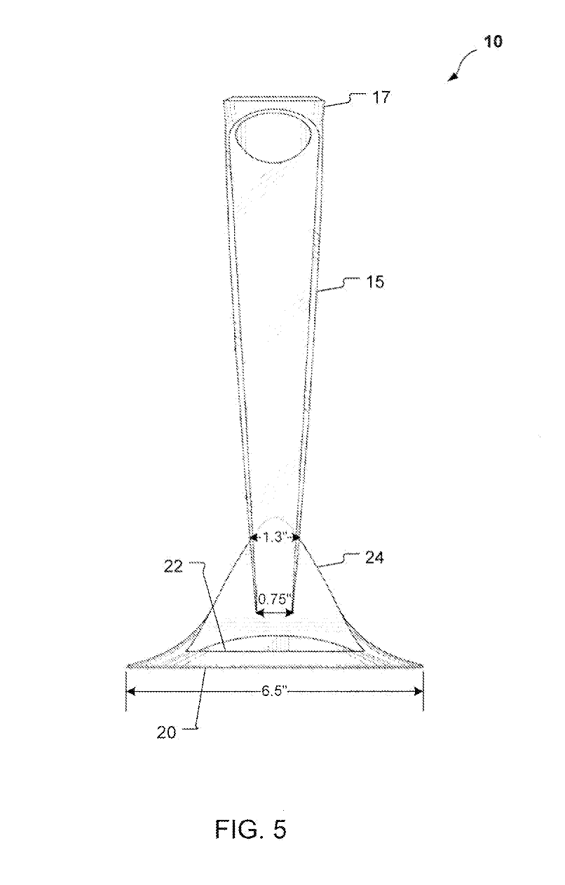

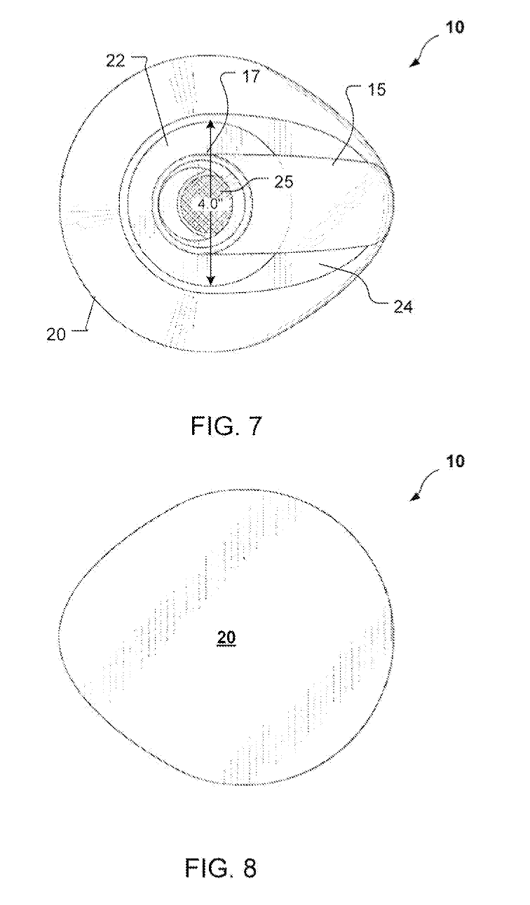

An embodiment of the wine aerator tower 10 that has been found to be suited for fitting a wine aerator 30 that is about 6 inches tall and about 2.25 inches wide at the widest point, and for filling standard sized wine glasses has the following dimensions. The overall height from the bottom of the base 20 to the top of the support adapter 17 is about 12.5 inches. The width of the bottom of the base 20, as viewed from the side (FIGS. 3 and 4), is about 7.375 inches. The width of the bottom of the base 20, as viewed from the front (FIG. 5), is about 6.5 inches. The diameter of the circular portion of the receptacle platform 22 (FIG. 7) is about 4.0 inches. The top of the support adapter 17 has an interior circular diameter of about 2.0 inches and an outside circular diameter of about 2.25 inches. The support adapter 17 is conical with the interior diameter decreasing from top to bottom to approximate the shape of the wine aerator 30. The stem 15 and support adapter 17 are sized such that the bottom of the wine aerator 30 is positioned about 9.5 inches above the receptacle platform 22 when the wine aerator 30 is in the support adapter 17 (see FIG. 1). The height of the transition member 24 (from the bottom of the base 20 to the top of the rear most portion of the transition member 24 as shown in FIG. 2) is about 3.25 inches. The width of the stem 15 at the transition member 24, as seen from the side in FIG. 3, is about 1.0 inch. The width of the stem 15 at the top of the transition member 24, as viewed from the front as in FIG. 5, varies from about 0.75 inches at the bottom to about 1.3 inches at the top.

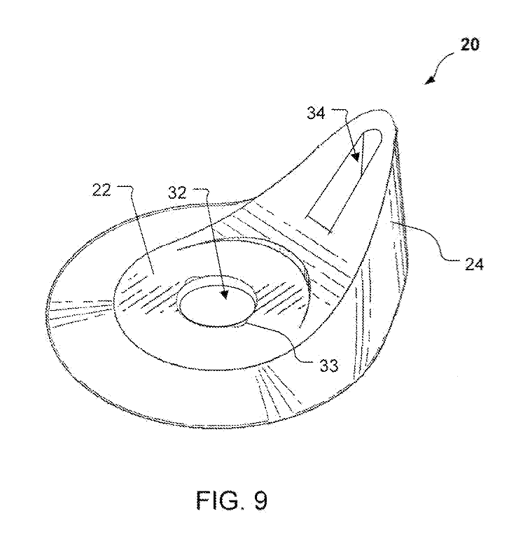

Referring to FIG. 9, the base 20 includes a splash guard aperture 32 and a stem aperture 34. The splash guard aperture 32 is sized to receive the splash guard 25. The splash guard aperture 32 also includes two fingernail apertures 33 that can be used to remove the splash guard 25. The floor of the splash guard aperture 32 is conical (volcano shaped) with the center being higher than the sides. A conical shaped floor can deflect liquid droplets to the sides of the splash guard aperture 32 rather than up through the splash guard 25. The stem aperture 34 is sized to receive an insertion portion (not shown) of the stem 15.

Referring to FIGS. 10A-10C, the splash guard 25 includes an outer frame 40, a splash screen 45, and, here nine, cross members 50. The outer diameter of the outer frame 40 is about 1.5 inches. The cross members 50 are located between the splash screen 45 and the back of the outer frame 40 such that the cross members 50 are above the conical floor of the splash guard aperture 32 when the splash guard 25 is placed within the splash guard aperture 32. The inner diameter of the outer frame 40 (the diameter of the splash screen 45) is about 1.375 inches. The outer frame 40 and the cross members 50 can be made of plastic. The splash screen 45 can be made of aluminum, vinyl, plastic, or other type of mesh material. In some embodiments, the splash guard 25 can include a back panel enclosing the cross members 50 between the splash screen 45 and the back panel. The back panel can include a conical portion as discussed above in reference to FIG. 9, and the floor of the splash guard aperture 32 may be flat.

In some embodiments, the outer frame 40 and the splash guard aperture 32 are sized and disposed such that the upper edges of the outer frame 40 and the splash guard screen 45 are substantially parallel with and do not protrude above (are level with or below) the receptacle platform 22. The outer frame 40 and the splash screen 45 are considered to be substantially parallel to the receptacle platform 22, assuming that the splash screen 45 has a flat upper surface and the receptacle platform 22 has a flat upper surface, when the upper surfaces of the splash screen 45 and the receptacle platform 22 are within 5 degrees or less of each other. In some embodiments, the splash screen 45 can have a non-flat surface. For example, the upper surface of the splash screen 45 could be conical, concave or convex. In some embodiments, the outer frame 40 and the splash screen 45 can extend slightly above (about one-sixteenth of an inch or less) the receptacle platform 22, in order to avoid interfering significantly with a wine glass positioned on the receptacle platform 22.

As seen in FIG. 108, the cross members 50 are triangular in cross section with a central peak or point 52 and two top surfaces 54 that extend away from the peak 52 partially horizontally and partially downward. This triangular cross section deflects droplets of liquid to the side rather than back up at the splash screen 45. This can help prevent liquid from exiting the interior of the splash guard 25. Other suitable cross sectional shapes for the cross members 50 may be used, including, for example, circular or elliptical.

While the principles of the disclosure have been described above in connection with specific apparatuses and methods, it is to be clearly understood that this description is made only by way of example and not as limitation on the scope of the disclosure. For example, an aerator tower may be used for an aerator that mixes a liquid other than wine with air or a gas other than air. Further, other cross-sectional shapes of splash guard cross members 50 may be used. For example, right triangles with only one top surface could be used, or semi-circular or other convex-shaped cross-sectional shapes could be used.

What is claimed is:

1. A wine aerator system comprising:
a wine aerator comprising a body defining a fluid flow path extending from a top opening of the body to a bottom opening of the body, the fluid flow path being configured to introduce air into a flow of wine passing from the top opening to the bottom opening of the body; and
a tower configured to receive the wine aerator, the tower including:
a base configured to be disposed on a horizontal surface and to receive a wine glass; and
a stem configured to extend upwardly from the base when the base is disposed on the horizontal surface, the stem including an adapter configured to removably receive the wine aerator such that the wine aerator is positioned above the base such that the wine glass can be positioned on the base and under the wine aerator to receive wine exiting the bottom opening of the wine aerator.

2. The wine aerator system of claim 1 wherein a first aperture is provided by the base, the system further comprising:
a splash guard configured to be removably placed into the first aperture and to reduce or inhibit splashing of drops of liquid being vertically received by the splash guard relative to a smooth surface.

3. The wine aerator system of claim 2 wherein the splash guard comprises a screen positioned substantially parallel to and level with or below the receptacle platform with the splash guard received by the first aperture.

4. The wine aerator system of claim 2 wherein a floor of the first aperture provides a convex portion.

5. The wine aerator system of claim 4 wherein the convex portion of the floor of the first aperture has a conical shape.

6. The wine aerator system of claim 2 wherein the splash guard comprises a plurality of cross members each having at least one top surface extending partially horizontally and partially downward.

7. The wine aerator system of claim 6 wherein a cross section of at least one of the cross members is triangular.

8. The wine aerator system of claim 2 wherein the base provides at least one fingernail aperture adjacent to and in fluid communication with the first aperture to facilitate removal of the splash guard from the first aperture.

9. The wine aerator system of claim 1 wherein the stem is configured to be removably coupled to the base.

10. The wine aerator system of claim 2 wherein the splash guard further comprises a back panel coupled to the outer frame, the back panel comprising a conical upper surface with a center of the conical upper surface being closer to the screen than a periphery of the conical upper surface.

11. A wine aerator tower for removably receiving a wine aerator, the tower comprising:
a base including a receptacle platform providing a first aperture;
a splash guard configured to be removably placed within the first aperture, the splash guard comprising:
an outer frame sized to fit within the first aperture, and
a screen attached to and held by the outer frame, the screen providing at least a portion of a top of the splash guard; and
a stem coupled to the base, the stem including a support adapter configured to removably receive a wine aerator such that the wine aerator is positioned vertically over the splash guard at a height sufficient to allow a receptacle to be positioned on the base below the wine aerator.

12. The wine aerator tower of claim 11 wherein a floor of the first aperture is conical with a center of the conical floor being higher than a periphery of the floor of the first aperture.

13. The wine aerator tower of claim 11 wherein the splash guard comprises a plurality of cross members each having at least one top surface extending partially horizontally and partially downward.

14. The wine aerator tower of claim 13 wherein a cross section of at least one of the cross members is triangular with a peak centered on a top of the at least one cross member.

15. The wine aerator tower of claim 11 wherein the base includes a transition member that extends upwards from the receptacle platform, a second aperture is provided by the transition member and the stem is coupled to the base via the transition member.

16. The wine aerator tower of claim 11 wherein the screen of the splash guard is positioned substantially parallel to and level with or below the receptacle platform with the splash guard received by the first aperture.

17. The wine aerator tower of claim 11 wherein the splash guard further comprises a back panel coupled to the outer frame.

18. The wine aerator tower of claim 17 wherein the back panel comprises a conical upper surface with a center of the conical upper surface being closer to the screen than a periphery of the conical upper surface.

19. The wine aerator tower of claim 11 wherein the base provides at least one fingernail aperture extending away from and in fluid communication with the first aperture.
